(19) United States
(12) Patent Application Publication
(10) Pub. No.: US 2004/0090385 A1
(43) Pub. Date: May 13, 2004

(54) Antenna with shaped radiation pattern

(76) Inventor: Roger Green, Warwickshire (GB)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/450,431

(22) PCT Filed: Dec. 12, 2001
(86) PCT No.: PCT/GB01/05513

(30) Foreign Application Priority Data
Dec. 14, 2000 (GB) 0030482.4
Feb. 16, 2001 (GB) 0103841.3

(51) Int. Cl. H01Q 1/24

(52) U.S. Cl. 343/702; 343/841; 343/700 MS

(57) ABSTRACT

A mobile telephone antenna 49 comprises an electrically insulating substrate 2 which is L-shaped in cross-section, and a driven element 3 formed by an outer electrically conductive layer applied to an inner surface of the substrate 2 and an inner electrically conductive layer 5 applied to the substrate 2 and spaced from the outer layer by an insulating gap. The gap extends to a transmitting edge of the antenna 1 such that two portions of the outer layer are spaced from a portion of the inner layer 5 along the edge by two insulating portions of the substrate 2. The antenna 49 also incorporated an impedance-correcting secondary antenna part 50 comprising an electrically conductive element extending upwardly from the inner layer 5 and constituting an inductive element which is tuned to the frequency of the transmitted radiation. Additionally the antenna 49 incorporates a shielding and reflecting electrically conductive layer, connected to the outer layer, applied to another inner surface of the substrate 2 so as to extend perpendicularly to the outer layer for a distance greater than the distance of the tip of the secondary antenna part 50 from the inner layer 5, and a body of a dielectric material 51 is provided between the shielding layer and the secondary antenna part 50 to contain the electromagnetic field. This shielding layer serves as a field contouring structure which contours the electromagnetic field associated with the antenna so that the transmitted radiation is reflected away from the head of the user. Such an antenna is designed to reduce the level of transmittal radiation in the vicinity of the user's head where such radiation might present a hazard.

This invention relates to antennas and is more particularly, but not exclusively, concerned with antennas for mobile telephones and other radio equipment.

Antennas for mobile telephones and other radio equipment tend to be based on well-established simple structures, which are usually quarter wave monopoles. The reason for the use of such antennas in such applications is due to their simplicity, and also their properties with respect to the transmission of radio energy in all directions relative to the transmitting and/or receiving units with which they are in contact. Because of the need for such antennas to be compact in mobile telephones, there is no space available for a more sophisticated arrangement where conventional techniques are utilised. However the simplicity of such antennas, and in particular their omnidirectional radiation performance, has led to concerns over possible health hazards. This is of particular concern in relation to mobile telephones which are intended to be held against the user's head in use since a substantial proportion of the transmitted radio energy will pass into the user's head. Of course, this can be alleviated by use of a hands-free kit which enables the telephone unit to be held at a distance from the user's head whilst the user speaks into a microphone/loudspeaker assembly connected to the unit by a lead. In addition, from a technical point of view, power is wasted by being transmitted into the user, even if a hands-free kit is being used.

There are ways of implementing compact antennas using dielectric techniques, which are beginning to appear in some mobile telephones, these techniques relying on the reduction in size which is made possible by radiating power within a dielectric environment prior to sending it out into free space. These techniques do indeed lead to a reduced antenna size, but nevertheless still produce a radiation field within the user's head, as well as elsewhere within the user's body. They require the use of a low loss dielectric material and fringe field effects at or near the dielectric surface.

U.S. Pat. No. 6,034,638 discloses antennas for use in portable communications devices in which an antenna is partially embedded within a semicircular dielectric blocks and a metal screen also of semicircular shape forms a back plate between the antenna and the head of the user. Although the presence of the block of dielectric material will have some effect on reducing the level of radiation reaching the user's head, the dielectric material will not provide shaping of the radiation pattern of the electromagnetic field. Thus the shielding effect of the dielectric material will be limited.

It is an object of the invention to provide a novel antenna construction which is of particular application in a mobile telephone and which is capable of reducing the level of transmitted radiation in locations where such radiation might present a hazard

According to the present invention there is provided an antenna comprising a planar conductive ground plane element, a conductive radiating element projecting transversely from the ground plane element, connection means for supplying an energising signal to the radiating element to generate a radiating electromagnetic field, a planar conductive shielding element for directing the electromagnetic field away from the user, and a body of dielectric material within which the electromagnetic field is propagated, the shielding element projecting transversely from the ground plane element to the same side of the ground plane element as the radiating element, and the body of dielectric material extending between the ground plane element, the shielding element and the radiating element, characterized in that at least part of the radiating element projects from the body of dielectric material, and the body of dielectric material has a convexly curved outer surface remotely of the ground plane element and the shielding clement for directing the electromagnetic field in directions away from the ground plane element and the shielding element.

Such an antenna can be designed to reduce the level of transmitted radiation in locations where such radiation might present a hazard, as will be more readily understood from the following description.

In order that the invention may be more fully understood, reference will now be made, by way of example, to the accompanying drawings, in which:

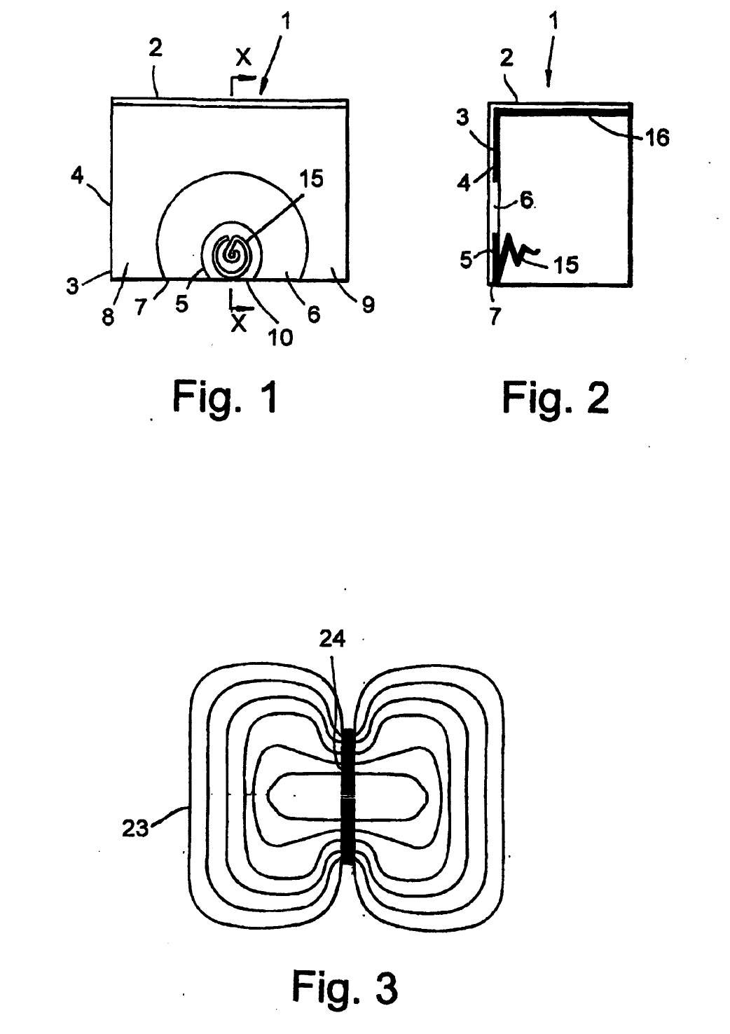

FIG. 1 is a plan view of an antenna, FIG. 2 showing a section along the line X-X in FIG. 1;

FIG. 3 is a diagram showing the electric field associated with the antenna of FIG. 1;

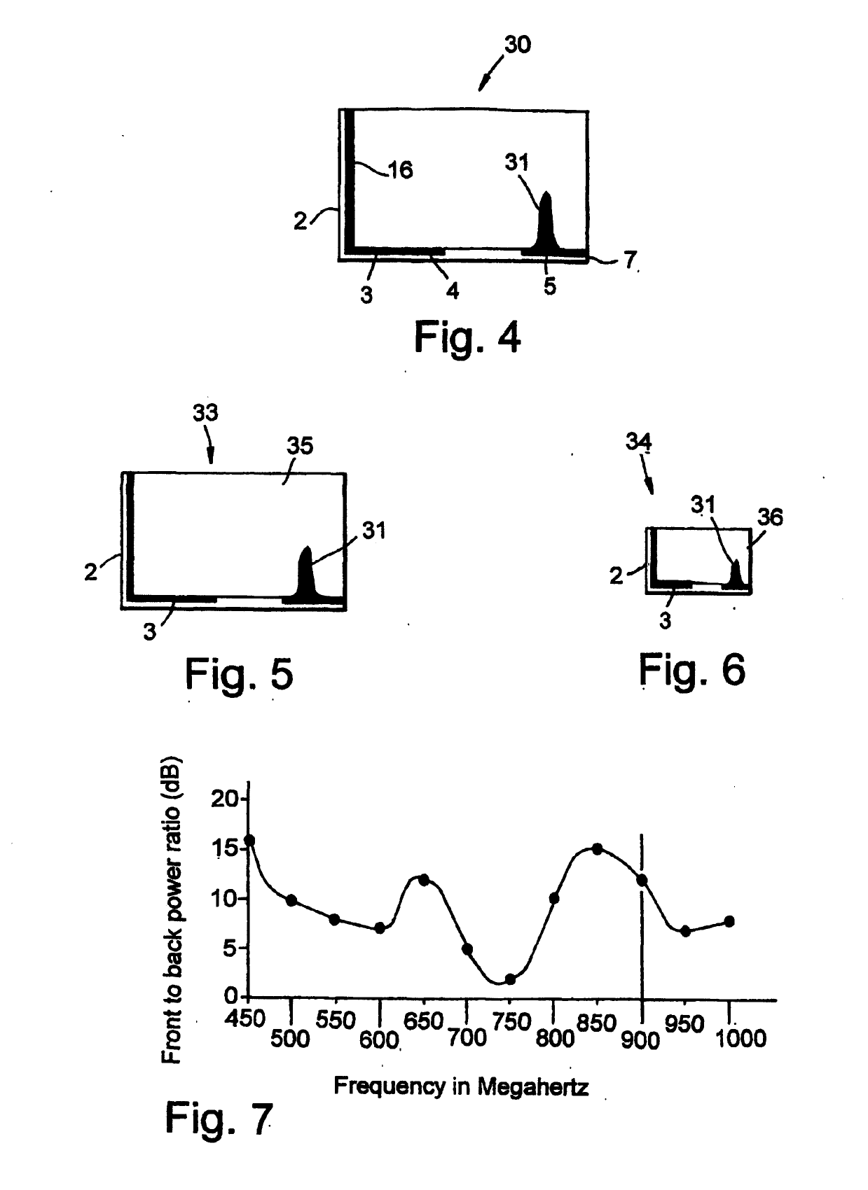

FIG. 4 is a sectional view through another antenna, FIGS. 5 and 6 showing the relative sizes of two antennas of this general design utilising dielectric materials of different dielectric constants;

FIG. 7 is a graph relating the typical front-to-back power ratio of signal transmitted by such an antenna to the signal frequency;

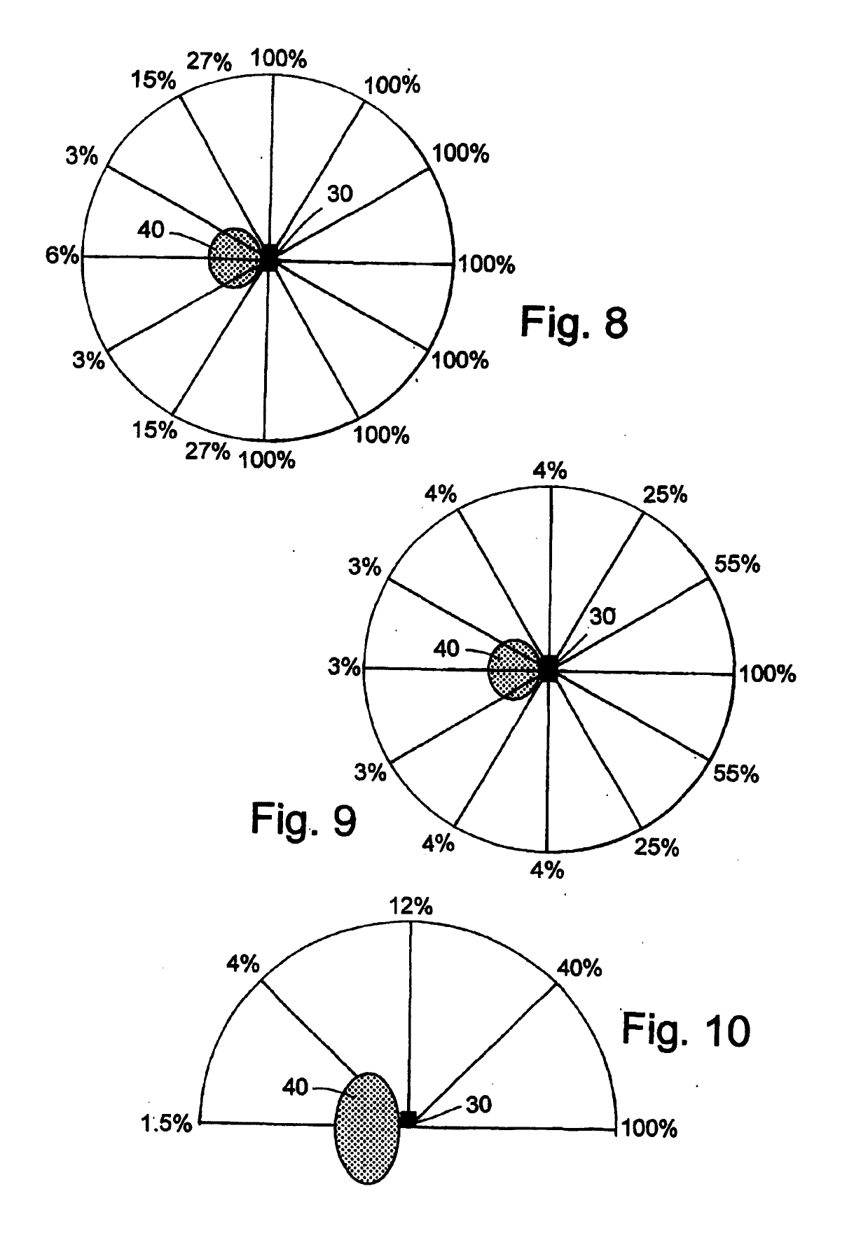

FIGS. 8, 9 and 10 are diagrams of the radio frequency signal strength around the user's head for vertically and horizontally polarised components of the signal in the horizontal plane and in the vertical plane (above the horizontal plane of FIGS. 8 and 9); and

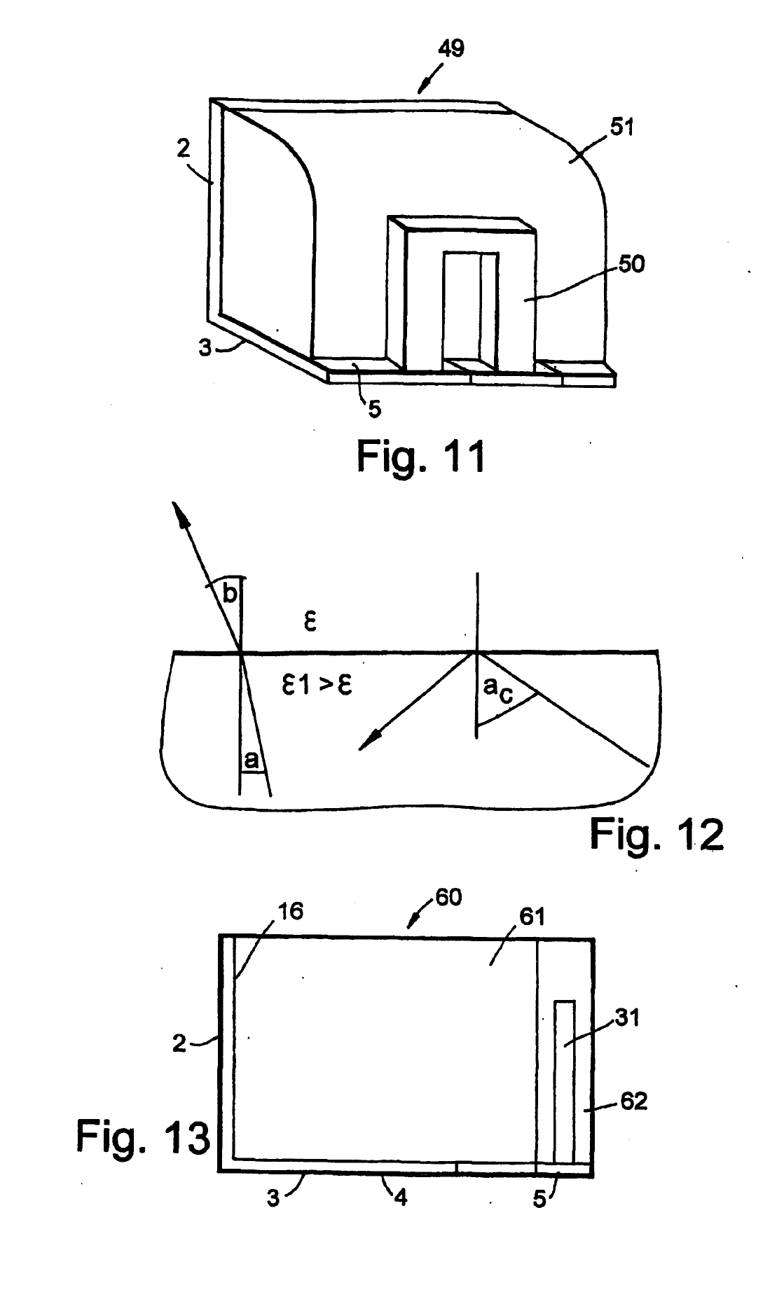

FIGS. 11, 12, 13, 14, 15 and 16 illustrate a number of embodiments of antenna in accordance with the invention.

The design of the embodiments of antenna in accordance with the invention to be described with reference to these drawings is based on the strategic combination of four elements, namely comprising (a) a planar conductive ground plane element for producing a shaped electromagnetic field in the horizontal plane, (b) a conductive radiating element projecting transversely from the ground plane element for enhancing the electrical characteristics produced by the ground plane element, including tuning the electromagnetic field produced by the ground plane element, (c) a planar conductive shielding element for reflecting the electromagnetic field away from the user, and (d) a field-shaping body of dielectric material modifying the radiation pattern of the electromagnetic field to ensure that stray electromagnetic fields are contained within the structure.

The effect of such an arrangement can be to reduce the quantity of radiation directed towards the user's head by a factor of between 10 and 30 times the radiation levels experienced with a conventional antenna used in mobile telephones. The driven element having a ground plane region may be a structure which is vertically small, although the structure can be quite sizeable laterally.

One problem with such a construction can be that the electrical impedance of the antenna can have the correct resistive component, but additionally can have a significant capacitive reactive impedance component. In order to reduce the size of the antenna, the structure is at least partially encased in a low loss, high dielectric constant material. The use of such a dielectric material can reduce the size of the antenna by a factor of (dielectric constant)^{1/2}. Thus, for example, use of a dielectric material of dielectric constant 4 enables each linear dimension of the antenna to be reduced to half of its value in the absence of such a dielectric material.

An antenna 1 shown in FIGS. 1 and 2 comprises an L-shaped printed circuit ground plane structure consisting of an electrically insulating substrate 2 and a driven element 3 connected to the circuitry in known manner and formed by an outer electrically conductive layer 4 applied to an inner surface of the substrate 2 and an inner electrically conductive layer 5 applied to the substrate 2 and spaced from the outer layer 4 by an insulating gap 6. The conductive layers 4 and 5 together constitute a diffraction antenna part. The gap 6 is arcuate in shape so that each point on the outer circumference of the inner layer 5 is at the same distance from the outer layer 4. Furthermore the gap 6 extends to a transmitting edge 7 of the antenna 1 such that two portions 8 and 9 of the outer layer 4 are spaced from a portion 10 of the inner layer 5 along the edge 7. The antenna 1 also incorporates an impedance-correcting secondary antenna part 15 comprising an electrically conductive helical element extending upwardly from the inner layer 5 which is tuned to the frequency of the transmitted radiation.

Additionally the antenna 1 incorporates a shielding electrically conductive layer 16, connected to the outer layer 4, applied to another inner surface of the substrate 2 so as to extend perpendicularly to the outer layer 4 for a distance greater than the distance of the tip of the secondary antenna part 15 from the inner layer 5. This shielding layer 16 also serves as an electromagnetic field deflecting structure which reflects the electromagnetic field associated with the antenna 1 so that the transmitted radiation is directed away from the user and adds to that already sent outwards from the antenna that direction. The whole of the antenna 1 is encased in a dielectric material of low loss for reasons which will become apparent from the following description

The antenna 1 of FIGS. 1 and 2 is designed for use in the UHF (Ultra High Frequency) band, although the same principle can be extended to a very wide range of frequencies. The antenna 1 has been used to detect TV signals in the frequency band 400 MHz to 900 MHz. Furthermore an antenna of half the size can operate successfully at the mobile phone frequencies of 1800 MHz or higher.

It will be appreciated that such an electromagnetic field generated by the antenna is similar to the electromagnetic field 23 produced by a quarter wave dipole 24 of height perpendicular to the plane, as shown in FIG. 3. Thus the driven element 3 of the antenna 1 shapes the electromagnetic field near the ground plane area, particularly the underside field, without taking up the vertical space of a monopole antenna, thereby reducing the height necessary to represent the antenna structure.

In the centre of the driven element 3 the impedance-correcting secondary antenna part 15 (a helical structure at lower frequencies, but a monopole or other structure at higher frequencies) serves two purposes, namely (a) to partially or wholly compensate for the capacitive reactive impedance component associated with the driven element by the inductance of the part 15 at the design frequency, and (b) to raise the point of peak electromagnetic field above the ground plane of the antenna, thereby making the antenna electrically higher. The driven element 3 is such as to keep the lower portion of the electromagnetic field on the underside of the element 3 close to the element 3.

The design of the impedance-correcting secondary antenna part 15 is such that it is less than the height of a shielding layer 16. The shielding layer 16 is actually a perpendicular ground plane which serves to contain the majority of the electromagnetic field from the top of the antenna part 15, and also to provide a backplane at a resonant distance, which reflects the radiation in a similar manner to the reflector in the popular Yagi antenna. The shielding layer may be shaped so as to optimise its shielding function, as well as to improve the shaping of the electromagnetic field transmitted. The secondary antenna part 15, which acts as a reduced height monopole, may be, for example, of helical form, so as to increase its overall length relative to the height over which it extends from the driven element 3 whilst ensuring that this height remains below the height limit of the shielding layer 16 with which it interacts. Furthermore the secondary antenna part 15 can be tapered so that the electromagnetic field is accentuated from the top of the part 15.

FIG. 4 shows a further antenna 30, and similar reference numerals as in FIGS. 1 and 2 are used in this figure to denote parts which are similar to the parts of the antenna 1 described with reference to FIGS. 1 and 2. Apart from being shown at a different orientation to the antenna 1, the antenna 30 differs from the antenna 1 only in the form of the impedance-correcting secondary antenna part which is denoted by the reference numeral 31 in FIG. 4. In this case the impedance-correcting secondary antenna part 31 is too short for helical implementation and is instead in the form of an electrically conductive pillar extending upwardly from the inner layer 5. Furthermore the top of the conductive pillar is tapered as shown so that the electric field is accentuated from the top of the part 31. The secondary antenna part may be inductive or capacitive, and other forms of antenna can be used in place of the tapered pillar or helix, such as a horizontal antenna instead of the vertical types already described.

As with the previously described arrangement the whole antenna is encased in a dielectric material of low loss. This means that the dimensions of the antenna can be scaled down, compared to a free-space implementation. The dielectric material serves a further useful function, in that the total internal reflection at the dielectric boundary with the surrounding air ensures that any stray electromagnetic fields that would otherwise have leaked out in a direction towards the user's head are reflected back within the dielectric material. Eventually the stray fields are channelled back out of the antenna in directions away from the user's head. This also increases the desired signal power away from the head of the user of the mobile phone, and thus increases the effectiveness of the antenna. This reflection effect is shown in FIG. 12 in which the dielectric constant ε1 of the dielectric material is greater than the dielectric constant ε of the surrounding air or metal, and a, b are the respective angles made with the normal by radiation which is refracted at the dielectric/air interface, whereas a_{c} is the angle made with the normal by radiation which is reflected at the dielectric/air interface.

Two such designs of antenna 33 and 34, based on the design of FIG. 4, incorporating dielectric encapsulation 35 and 36 are shown in FIGS. 5 and 6. The dielectric materials for the encapsulation 35 and the encapsulation 36 have different dielectric constants, and FIGS. 5 and 6 illustrate the fact that the size of the antenna can be varied by changing the dielectric constant of the encapsulation used.

In a first embodiment of antenna in accordance with the invention, in order to increase the resistance component of the electrical impedance, the impedance-correcting secondary antenna part is a folded monopole in the form of a U-shaped element 50, as shown in FIG. 11. Each arm of the U-shaped element is of the same size as the pillar in the single monopole arrangement of FIGS. 4 to 6, and one of the arms is connected directly to the conductive inner layer 5. The antenna of FIG. 11 is surrounded by dielectric encapsulation 51 with the exception of the U-shaped element 50 that projects from the dielectric encapsulation 51. In other variants the impedance correcting secondary antenna part is constituted by other forms of antenna structure such that, in each case, the rearwardly extending part of the electromagnetic field is still attracted towards the shielding element and not towards the user's head. Other forms of antenna include horizontal types such as the horizontal radiator.

In some applications it may be advantageous for the dielectric material to be a polymer material in which high dielectric constant ceramics or other materials are embedded This has the advantage that it is easier to form the material for the purposes of shaping of the electromagnetic field, and also to graduate the dielectric constant spatially within the material if desired.

In certain circumstances, it may be desirable to have one scaling factor for the shielding part of the antenna, and another scaling factor to define the size of the helix, monopole, or other impedance-correcting part of the antenna. FIG. 13 shows an antenna 60 surrounded by dielectric encapsulation 61 of one dielectric constant ε1, and the impedance-correcting part 31 surrounded by dielectric encapsulation 62 of another dielectric constant ε2. This permits the scaling factor associated with the impedance-connecting part 31 to be different to the scaling factor for the remainder of the antenna. For example, if the dielectric constant of the dielectric encapsulation 62 was 16, then the impedance-connecting part would be a quarter of the physical size that it would be in free space. Also, if the dielectric constant of the dielectric field deflector region, i.e. the bulk of the structure, was 100, then the distance of the impedance-correcting part 31 from the shielding layer 16 would only need to be one tenth of a quarter of the wavelength of the electromagnetic radiation being transmitted. This allows, in this example, a higher impedance-correcting part 31 than if the whole system were encapsulated in a single dielectric material.. The reason why this might be desirable is related to the side-effects, if the impedance-correcting part 31 were surrounded by a high dielectric constant material, namely, fringe fields effects at the metal-dielectric interface.

A further enhancement of any of the forms of antenna described may be achieved by use of a coating layer of a further dielectric constant ε3 covering the antenna The benefit of this is that the wave impedance of the antenna may be more closely matched to the wave impedance of free space by such a layer. This is analogous to the “anti-reflection” film on optical lenses.

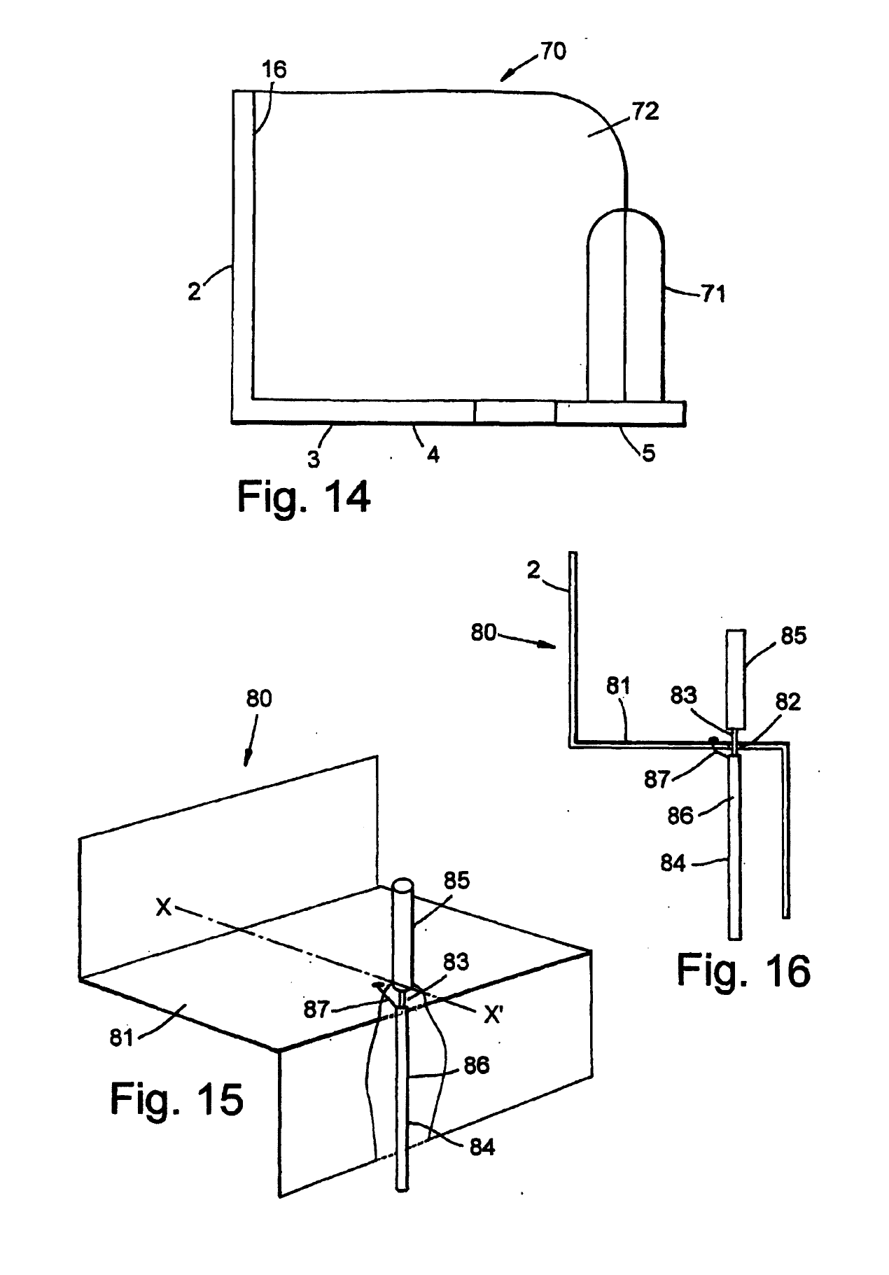

FIG. 14 shows a further embodiment of antenna 70 in accordance with the invention in which, in order to get around the matching problems, use is made of an impedance-correcting secondary antenna part 71 which is partially embedded in dielectric encapsulation 72 and which is partially-exposed (that is not covered with dielectric material). In this case, no extra dielectric layer is used, and the antenna 70 still behaves electrically as though it were completely encased in dielectric material. This maintains the small size advantage of the dielectric technique previously described, and cuts down on internal reflections within the structure.

FIG. 15 shows a further embodiment of antenna 80 in accordance with the invention which does not incorporate the diffraction part of the other embodiments, but which instead has a continuous electrically conductive layer 81 over the whole of the electrically insulating substrate 2, which, in this case, is substantially Z-shaped in section, and a coaxial cable 84 connected to a secondary antenna part 85. The antenna 80 is shown partially cut away in FIG. 15 to reveal the cable 84. As best seen in the cross-section along the line X-X′ shown in FIG. 16, a hole 82 extends through the substrate 2 and the layer 81 to allow a core conductor 83 of the cable 84 to pass through the hole 82 without electrically contacting the layer 81. Furthermore the core conductor 83 of the cable 84 is electrically connected to the secondary antenna part 85 which extends upwardly above the hole 82, the conductive sheath 86 of the cable 84 being electrically connected to the layer 81 as shown at 87. This antenna 80 operates similarly to the other embodiments having diffraction parts, and is partially surrounded by dielectric encapsulation as described above.

The effect of the different elements used in the various embodiments of the invention described above is to produce a compact antenna serving to direct transmitted radiation away from the shielding element, thus reducing radiation in that direction, when used for transmission, by a typical 10 to 30 times. The corresponding radiated field intensity in the forward direction (that is away from the shielding element) is approximately doubled by comparison with such radiation produced by a standard antenna. Thus such an antenna permits power saving when a certain radiated signal power level is required, because the radiated power in the required direction is increased by a factor of 4 for the same electronic excitation. This means that, in portable applications such as mobile telephones, battery life is extended or, conversely, batteries can be smaller (that is of lower capacity) for the same effective range of transmission.

FIG. 7 shows a graph of typical “front-to-back” power ratio obtained with an antenna in accordance with the invention, that is of the ratio of the power in the forward direction relative to the power in the opposite direction, as a function of frequency. The graph shows the front-to-back ratio of the transmitted power in dB, which is in a logarithmic ratio, and the frequency in MHz. By way of example, at a frequency of 850 MHz, the front-to-back ratio of the transmitted power is about 15 dB, which corresponds to approximately 31 times. In other words, the transmitted power in the backward direction, which may be towards the user's head in the case of a mobile phone, is only 1/30^{th} of the usual power. By contrast, the transmitted power in the required forward direction is up to four times the amount given out by a standard antenna, so that a net advantage of up to 120 times (in terms of overall reduction of power in the backward direction) can be achieved if the transmitter power is reduced by the factor of four. This reduces considerably any possible health hazards.

FIG. 8 shows the measured radio frequency signal strength in the horizontal plane around the antenna 30 for the vertically polarised signal radiated by such an antenna, relative to the user's head 40. FIG. 9 shows the measured radio frequency signal strength in the horizontal plane around the antenna 30 for the horizontally polarised signal radiated by such an antenna, relative to the user's head 40. Both these figures show that the antenna 30 radiates minimally in the direction of the user's head 40, for both horizontal and vertical components of the emitted radiation. FIG. 10 shows the measured radio frequency signal strength in the vertical plane for the vertically polarised signal (shown only for the radiation pattern above the horizontal plane of FIGS. 8 and 9), relative to the user's head 40. Again only minimal radiation is produced in the direction of the user's head 40.

Antennas in accordance with the invention may also be used in GSM mobile telephones, UMTS, HILPERLAN, Bluetooth systems, UHF TV antennas, Smart cards, compact remote sensor/transponders, cordless telephones and other consumer products.

The use of such antennas can provide a number of design advantages, as follows:

1. Separation of the antenna part from the shielding system is possible, to allow separate design functionality.

2. Contouring of the dielectric constant can be achieved in an analogous way to refractive index contouring in an optical fibre.

3. Such an antenna can be combined with an optical antenna to provide an integrated “dual band” antenna structure (with GHz transmission/reception plus THz tranmission/reception for microwave optical antennas).

4. Multiband performance may be obtained by providing dedicated chip antennas (dedicated to different frequency bands) side by side.

In conclusion, a compact, directional antenna structure has been demonstrated. The concept may be viewed as providing an antenna within a field shaping dielectric material and a reflector element. Using “optical” techniques, the electromagnetic field can be guided, and the front-to-back ratio (FBR) can be increased. In the basic prototype, the front-to-back ratio was about 15 dB, but this can be increased using standard impedance matching techniques at the dielectric interface. The radiation pattern of the various possible antenna structures can be shaped by dielectric techniques as well as by electrode geometry. Furthermore such antennas can be produced as cheaply as existing types of antenna, and can utilise existing dielectric processing techniques. In this way a new chip antenna technology, which may be termed “Radio Optical Antenna (ROA)” technology, can be achieved.

1. An antenna comprising (a) a driven element having a ground plane region for producing a shaped electromagnetic field, (b) a secondary antenna part connected to the driven element for tuning the electromagnetic field produced by the driven element, and (c) a shielding element for directing the electromagnetic field away from the user, a body of dielectric material within which the electromagnetic fields is propagated being provided between the secondary antenna part and the shielding element.

2. An antenna according to claim 1, wherein the secondary antenna part and the shielding element extend substantially parallel to one another and transverse to the ground plane region.

3. An antenna according to claim 1 or 2, wherein the driven element comprises an electrically conductive layer disposed in an electrically insulating substrate and electrically insulated from the secondary antenna part.

4. An antenna according to claim 1 or 2, wherein the driven element comprises an electrically conductive outer layer disposed in a common plane with an electrically conductive inner layer which is electrically insulated from the outer layer so that the electric field lines of the electromagnetic field extends between the outer and inner layers.

5. An antenna according to claim 3, wherein the driven element incorporates a transmitting region having two electrically conductive portions on one polarity separated by, and electrically insulated from, an electrically conductive portion of the opposite polarity so that electric field lines of the electromagnetic field extend between one of the portions of one polarity and the portion of the opposite polarity and further field lines of the electromagnetic field extends between the other of the portions of one polarity and the portion of the opposite polarity.

6. An antenna according to claims 1 to 5, wherein the secondary antenna part comprises an element extending transversely from the driven element which is substantially planar.

7. An antenna according to claim 6, wherein the element of the secondary antenna part is twisted so as to increase its overall length relative to the transverse distance over which the element extends from the driven element.

8. An antenna according to claim 6 or 7, wherein the secondary antenna part is tapered from its end adjacent to the driven element towards its end furthest away from the driven element.

9. An antenna according to any preceding claim 1, wherein the shielding element comprises an electrically conductive shielding layer connected to the driven element.

10. An antenna according to any preceding claim 1, wherein the shielding element comprises an electrically conductive shielding layer extending transversely from the driven element to an extent greater than the secondary antenna part.

11. An antenna according to any preceding claim 1, wherein the secondary antenna part is at least partially encapsulated in dielectric material having a different dielectric constant to the dielectric material within which at least part of the remainder of the antenna is encapsulated.

12. An antenna according to claim 11, which is coated with a layer of dielectric material having a different dielectric constant to the or each other dielectric material.

13. An antenna according to any preceding claim 1, wherein the dielectric material provides a dielectric-air interface from which electromagnetic radiation is totally internally reflecting for directing such radiation away from the user.

14. An antenna comprising (a) a driven element having a ground plane region for producing a shaped electromagnetic field, (b) a secondary antenna part connected to the driven element for tuning the electromagnetic field produced by the driven element, and (c) a shielding element for directing the electromagnetic field away from the user, wherein the secondary antenna part and the shielding element extend substantially parallel to one another and transverse to the ground plane region.

15. An antenna according to claim 14, wherein a body of dielectric material within which the electromagnetic field is propagated is provided between the secondary antenna part and the shielding element.

16. An antenna according to any preceding claim 1, which is designed designated for use with radio frequencies.

17. A transmitter such as a mobile telephone, incorporating an antenna according to any preceeding claim 1.
